(19) United States
(12) Patent Application Publication
(10) Pub. No.: US 2007/0129025 A1
(43) Pub. Date: Jun. 7, 2007

(54) Open loop polar transmitter having on-chip calibration

(76) Inventors: John E. Vasa, Irvine, CA (US); William J. Domino, Yorba Linda, CA (US); Norman J. Beamish, Killiney (IE); Morten Damgaard, Laguna Hills, CA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 11/292,173

(22) Filed: Dec. 1, 2005

(51) Int. Cl. H04B 1/04

(52) U.S. Cl. 455/114.2

(57) ABSTRACT

An on-chip calibration system comprises a transmitter, a receiver, a phase and amplitude determination element configured to determine amplitude and phase characteristics of an output signal generated in the transmitter, the signal representing transmitter characteristics, an amplitude comparison element configured to compare the signal representing transmitter characteristics with a desired amplitude signal and generate an amplitude compensation signal, an AM predistortion element configured to modify an ideal AM signal with the amplitude compensation signal, a phase comparison element configured to compare the signal representing transmitter characteristics with a desired phase signal and generate a phase compensation signal, and a PM predistortion element configured to modify an ideal phase signal with the phase compensation signal.

### BACKGROUND OF THE INVENTION

1. Field of the Invention

This invention relates generally to transceiver architecture in a wireless portable communication device. More particularly, the invention relates to a system for on-chip calibration of an open-loop polar loop transmitter.

2. Related Art

Radio frequency (RF) transmitters are found in many one-way and two-way communication devices, such as portable communication devices, (cellular telephones), personal digital assistants (PDAs) and other communication devices. An RF transmitter must transmit using whatever communication methodology is dictated by the particular communication system within which it is operating. For example, communication methodologies typically include amplitude modulation, frequency modulation, phase modulation, or a combination of these. In a typical GSM mobile communication system using narrowband TDMA technology, a GMSK modulation scheme supplies a low noise phase modulated (PM) transmit signal to a non-linear power amplifier directly from an oscillator.

In such an arrangement, a non-linear power amplifier, which is highly efficient, can be used, thus allowing efficient transmission of the phase-modulated signal and minimizing power consumption. Because the modulated signal is supplied directly from an oscillator, the need for filtering, either before or after the power amplifier, is minimized. Other transmission standards, such as that employed in IS-136, and in the enhanced data rates for GSM evolution (EDGE) standard, use a modulation scheme in which a transmit signal contains both a PM component and an amplitude modulated (AM) component. Standards such as these increase the data rate without increasing the bandwidth of the transmitted signal. Unfortunately, existing GSM modulation schemes are not easily adapted to transmit a signal that includes both a PM component and an AM component. One reason for this difficulty is that in order to transmit a signal containing a PM component and an AM component, a highly linear power amplifier is required. Unfortunately, highly linear power amplifiers are very inefficient, thus consuming significantly more power than a non-linear power amplifier and drastically reducing the life of the battery or other power source.

For transmitters that operate in the EDGE standard, to maximize power amplifier efficiency, an open-loop polar transmit architecture has been developed. Such an architecture consumes less power than closed power control loop systems. In such an open loop architecture, the AM is applied to the power amplifier by controlling the bias current, collector voltage or a combination of these using an analog voltage control signal. However, due to stringent requirements for modulation accuracy and spectral purity, as well as output power range and control accuracy, the open loop architecture faces design challenges. For example, the linearity and range of power control input must be closely controlled. Even with a highly linear control range, pre-distortion is typically applied to the AM signal to achieve sufficiently accurate control of the amplitude variations over the full range of output power levels. In addition, the AM-PM conversion of the power amplifier must also be compensated, typically by applying a pre-distortion factor to the PM signal as well. The AM and PM pre-distortion must compensate for power amplifier variations over temperature, supply voltage and output power. Unfortunately, this typically requires that the power output characteristics of each transmitter be determined and calibrated when the transmitter is built. This consumes valuable manufacturing and testing resources, and does not take into account long term changes to the characteristics of the transmitter as it ages.

### SUMMARY

Embodiments of the invention include an on-chip calibration system for a transceiver, comprising a transmitter, a receiver, a phase and amplitude determination element configured to determine amplitude and phase characteristics of an output signal generated in the transmitter, the signal representing transmitter characteristics, an amplitude comparison element configured to compare the signal representing transmitter characteristics with a desired amplitude signal and generate an amplitude compensation signal, an AM predistortion element configured to modify an ideal AM signal with the amplitude compensation signal, a phase comparison element configured to compare the signal representing transmitter characteristics with a desired phase signal and generate a phase compensation signal, and a PM predistortion element configured to modify an ideal phase signal with the phase compensation signal.

Related methods of operation are also provided. Other systems, methods, features, and advantages of the invention will be or become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE FIGURES.

The invention can be better understood with reference to the following figures.

The components within the figures are not necessarily to scale, emphasis instead being placed upon clearly illustrating the principles of the invention. Moreover, in the figures, like reference numerals designate corresponding parts throughout the different views.

FIG. 1 is a block diagram illustrating a simplified portable transceiver.

FIG. 2 is a block diagram illustrating an open-loop polar RF transmitter and a portion of a receiver in accordance with an embodiment of the invention.

FIG. 3 is a graphical representation of the relationship between control voltage V_{APC} and output power, represented as a voltage, V_{RF} of the power amplifier of FIGS. 1 and 2.

FIG. 4 is a flow chart describing the operation of an embodiment of the invention.

FIGS. 5A and 5B are a flow chart collectively illustrating the measurement of the AM-AM and the AM-PM characteristics of the power amplifier referred to in FIG. 4.

FIG. 6 is a flow chart illustrating the calibration of the output power of the power amplifier using AM-AM and AM-PM characteristics referred to in FIG. 4.

FIGS. 7A and 7B are a flow chart collectively illustrating an embodiment of the invention in which the on-chip calibration is performed periodically when the portable transceiver is in operation.

### DETAILED DESCRIPTION

Although described with particular reference to a portable transceiver, the open loop polar transmitter having on-chip calibration can be implemented in any system in which a transmitted signal includes both an AM component and a PM component, and in which the AM component is applied to the control port of the power amplifier.

The open loop polar transmitter having on-chip calibration can be implemented in hardware, software, or a combination of hardware and software. When implemented in hardware, the open loop polar transmitter having on-chip calibration can be implemented using specialized hardware elements and logic. When the open loop polar transmitter having on-chip calibration is implemented partially in software, the software portion can be used to adaptively apply the AM and PM pre-distortion to the transmitter, thereby compensating for the AM and PM characteristics during normal use of the transmitter, if these characteristics should change as a function of temperature, aging or other factors. The software can be stored in a memory and executed by a suitable instruction execution system (microprocessor). The hardware implementation of the open loop polar transmitter having on-chip calibration can include any or a combination of the following technologies, which are all well known in the art: discrete electronic components, a discrete logic circuit(s) having logic gates for implementing logic functions upon data signals, an application specific integrated circuit having appropriate logic gates, a programmable gate array(s) (PGA), a field programmable gate array (FPGA), etc.

The software for the open loop polar transmitter having on-chip calibration comprises an ordered listing of executable instructions for implementing logical functions, and can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM), a read-only memory (ROM), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via for instance, optical scanning of the paper or other medium, then compiled, interpreted or otherwise processed in a suitable manner if necessary, and then stored in a computer memory.

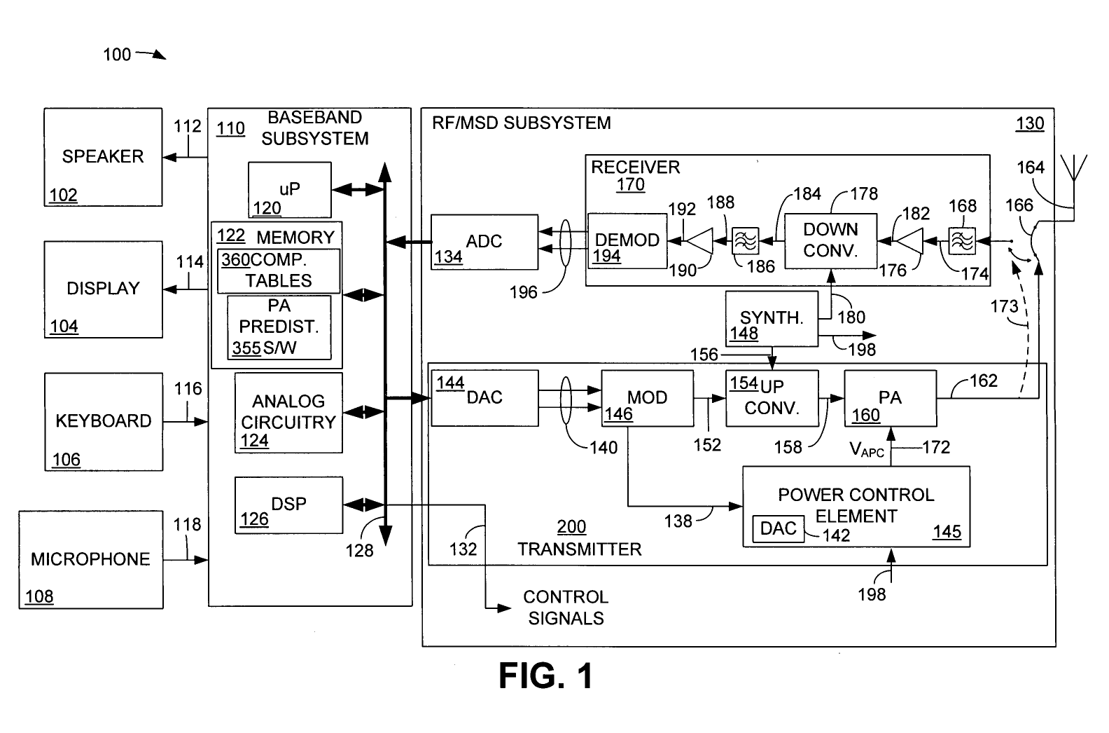

FIG. 1 is a block diagram illustrating a simplified portable transceiver 100. The portable transceiver 100 includes speaker 102, display 104, keyboard 106, and microphone 108, all connected to baseband subsystem 110. In a particular embodiment, the portable transceiver 100 can be, for example but not limited to, a portable telecommunication handset such as a mobile cellular-type telephone. The speaker 102 and the display 104 receive signals from the baseband subsystem 110 via connections 112 and 114, respectively, as known to those skilled in the art. Similarly, the keyboard 106 and the microphone 108 supply signals to the baseband subsystem 110 via connections 116 and 118, respectively. The baseband subsystem 110 includes microprocessor (μP) 120, memory 122, analog circuitry 124, and digital signal processor (DSP) 126 in communication via bus 128. The bus 128, though shown as a single bus, may be implemented using a number of busses connected as appropriate among the subsystems within baseband subsystem 110. The microprocessor 120 and the memory 122 provide the signal timing, processing and storage functions for the portable transceiver 100. If portions of the open loop polar transmitter having on-chip calibration are implemented in software, then the memory 122 also includes power amplifier pre-distortion software 355 that can be executed by the microprocessor 120, the DSP 126 or by another processor, and compensation tables 360 that are developed based on the performance of the transmitter 200 and used to compensate for non-linearities in the power amplifier, to be described below.

The analog circuitry 124 provides the analog processing functions for the signals within the baseband subsystem 110. The baseband subsystem 110 communicates with the radio frequency (RF)/mixed signal device (MSD) subsystem 130 via the bus 128.

The RF/MSD subsystem 130 includes both analog and digital components. For example, the RF/MSD subsystem 130 includes a transmitter 200, a receiver 170, an analog-to-digital converter 134, and one or more analog-to-digital converters (DAC). In this embodiment, the transmitter 200 includes a DAC 144. The DAC 144 processes the digital transmit data to be supplied to the modulator 146.

In one embodiment, the baseband subsystem 110 provides control signals via connection 132 that may originate from the DSP 126 from microprocessor 120, or from another element, and are supplied to a variety of points within the RF/MSD subsystem 130. It should be noted that, for simplicity, only the basic components of portable transceiver 100 are illustrated.

The ADC 134 and the DAC 144 also communicate with microprocessor 120, memory 122, analog circuitry 124 and DSP 126 via bus 128. The DAC 144 converts the digital communication information within baseband subsystem 110 into an analog signal for transmission by the transmitter 200 via connection 140. Connection 140, while shown as two directed arrows, includes the information that is to be transmitted by RF/MSD subsystem 130 after conversion from the digital domain to the analog domain.

The DAC 144 may operate on either baseband in-phase (I) and quadrature-phase (Q) components or phase and amplitude components of the information signal. In the case of I and Q signals, the modulator 146 is an I/Q modulator as known in the art while in the case of phase and amplitude components, the modulator 146 operates as a phase modulator utilizing only the phase component and passes the amplitude component, unchanged, to the power control element 145.

The modulator 146 modulates either the I and Q information signals or the phase information signal received from the DAC 144 onto an LO signal and provides a modulated signal via connection 152 to upconverter 154. It will be understood by those skilled in the art that in other embodiments the operations performed by the modulator 146 and upconverter 154 can be performed by a single block.

The upconverter 154 receives a frequency reference signal (referred to as a “local oscillator” or “LO” signal) from synthesizer 148 via connection 156. The synthesizer 148 determines the appropriate frequency to which the upconverter 154 will translate the modulated signal on connection 152.

The upconverter 154 supplies the modulated signal at the appropriate transmit frequency via connection 158 to power amplifier 160. The power amplifier 160 amplifies the modulated signal on connection 158 to the appropriate power level for transmission via connection 162 to antenna 164. Illustratively, switch 166 is a three-way switch that controls whether the amplified signal on connection 162 is transferred to antenna 164, directly from the transmitter output to the receiver input or whether a received signal from antenna 164 is supplied to filter 168 in the receiver 170. In one embodiment, the switch 166 is positioned so that the output of the transmitter 200 is supplied directly to the receiver 170 so that the transmitter characteristics, and in particular, the AM-AM and AM-PM characteristics can be analyzed and simultaneously compensated. In an alternative embodiment, power from the transmitter 200 is supplied to the receiver 170 through a leakage path illustrated using reference numeral 173 or via overlap between the transmit band and the receive band. The operation of switch 166 is controlled by a control signal from baseband subsystem 110 via connection 132.

The power control element 145 operates in an open loop configuration and includes a DAC 142. The DAC 142 supplies a voltage reference signal referred to as V_{APC}. The voltage signal V_{APC} is used to control the power output of the power amplifier and to supply the AM portion of the transmit signal to the power amplifier via a control input on connection 172. The power control element 145 also receives the LO signal from synthesizer 148 via connection 198.

A signal received by antenna 164 may, at the appropriate time determined by baseband subsystem 110, be directed via switch 166 to a receive filter 168. The receive filter 168 filters the received signal and supplies the filtered signal on connection 174 to a low noise amplifier (LNA) 176. The receive filter 168 may be a bandpass filter that passes all channels of the particular cellular system where the portable transceiver 100 is operating. As an example, for a 900 MHz GSM system, receive filter 168 would pass all frequencies from 925.1 MHz to 959.9 MHz, covering all 174 contiguous channels of 200 kHz each. The purpose of the receive filter 168 is to reject all frequencies outside the desired region. An LNA 176 amplifies the very weak signal on connection 174 to a level at which downconverter 178 can translate the signal from the transmitted frequency back to a baseband frequency. Alternatively, the functionality of the LNA 176 and the downconverter 178 can be accomplished using other elements, such as, for example but not limited to, a low noise block downconverter (LNB).

The downconverter 178 receives an LO signal from synthesizer 148 via connection 180. The LO signal determines the frequency to which to downconvert the signal received from the LNA 176 via connection 182. The downconverted frequency is called the intermediate frequency (IF). In some transceiver embodiments, the received RF signal is downconverted directly to a baseband (0 Hz) or a near-baseband signal. This architecture is referred to as a direct conversion receiver (DCR). If implemented as a direct conversion receiver, one or more baseband filters will be substituted for the IF filter 186. The downconverter 178 sends the downconverted signal via connection 184 to a channel filter 186, also called the “IF filter.” The channel filter 186 filters the downconverted signal and supplies it via connection 188 to an amplifier 190. The channel filter 186 selects the one desired channel and rejects all others. Using the GSM system as an example, only one of the 174 contiguous channels is actually to be received. After all channels are passed by the receive filter 168 and downconverted in frequency by the downconverter 178, only the one desired channel will appear precisely at the center frequency of channel filter 186. The synthesizer 148, by controlling the local oscillator frequency supplied on connection 180 to downconverter 178, determines the selected channel. The amplifier 190 amplifies the received signal and supplies the amplified signal via connection 192 to demodulator 194. The demodulator 194 recovers the transmitted analog information and supplies a signal representing this information via connection 196 to the ADC 134. The ADC 134 converts these analog signals to a digital signal at baseband frequency and transfers it via bus 128 to DSP 126 for further processing.

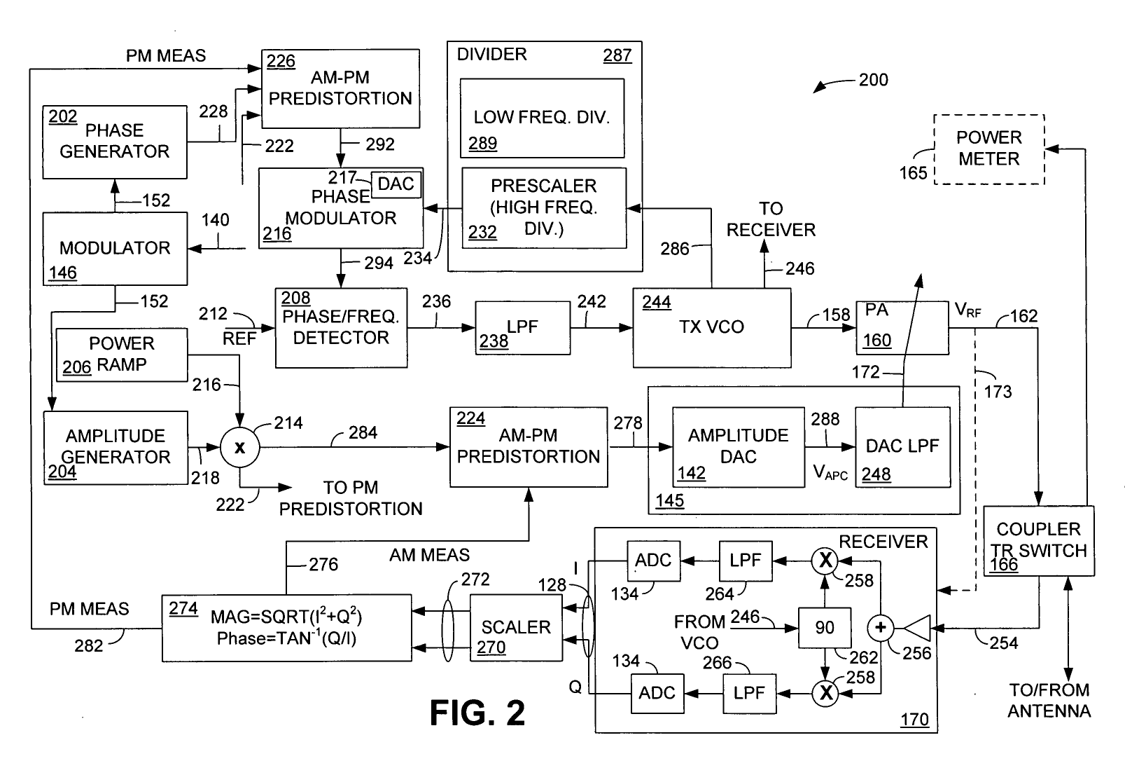

FIG. 2 is a block diagram illustrating a polar loop RF transmitter 200 and a portion of a receiver 170 in accordance with an embodiment of the invention. In the embodiment illustrated in FIG. 2 an I/Q modulator 146 generates a pair of I and Q information signals in either the GSM or EDGE format. One copy of these I and Q information signals is sent via connection 152 to a phase generator 202, which, upon being presented with an I and Q signal pair at its input, will generate the phase of that I and Q signal pair at its output on connection 228. A duplicate copy of the I and Q signal pair from the modulator 146 is sent via connection 152 to an amplitude generator 204. The amplitude generator 204 produces at its output on connection 218 a signal corresponding to the amplitude of the I and Q signal pair at its input on connection 152. The operation of the phase generator 202 and the amplitude generator 204 is well known in the art.

The output of the phase generator 202 is sent to an AM-PM predistortion element 226, which adds a phase offset value to the signal on connection 228 based on the amplitude on connection 222. The AM-PM predistortion is a variable phase term which is a function of the amplitude. Specifically, phase is a non-linear function of amplitude. When using a non-linear power amplifier 160 the phase depends on the output power. The output of the AM-PM predistortion element 226 is supplied via connection 292 to a phase modulator 216, which includes a phase DAC 217 and which can be implemented as a sigma-delta modulator. Alternatively, the phase can be modulated using a number of different techniques that are known in the art. The AM-PM predistortion element 226 will be discussed in greater detail below. The phase modulator 216 uses the phase input on connection 292 to modulate the phase of an RF signal centered at an RF carrier the frequency, which is determined externally to the transmitter 200. The output of the phase modulator 216 is a phase modulated signal and is sent to a phase/frequency detector 208. The phase/frequency detector 208 compares the phase of the signal on connection 294 with a phase reference signal supplied via connection 212. The phase reference signal on connection 212 is supplied by an oscillator (not shown) as known in the art.

The phase/frequency detector 208 detects any phase difference between the signal on connection 294 and the signal on connection 212 and places a signal on connection 236 that has an amplitude proportional to the difference. When the phase difference reaches 360°, the output of phase/frequency detector 208 on connection 236 will become proportional to the frequency difference between the signals on connections 294 and 212.

The output of phase/frequency detector 208 on connection 236 is a digital signal having a value of either a 0 or a 1 with a very small transition time between the two output states. This signal on connection 236 is supplied to low-pass filter 238, which integrates the signal on connection 236 and places a DC signal on connection 242 that controls the frequency of the transmit voltage control oscillator (TX VCO) 244. The output of TX VCO 244 is supplied via connection 158 directly to the power amplifier 160. The output of the TX VCO 244 is also supplied via connection 286 to a prescaler 232. The prescaler 232 is part of a divider 287 in the PLL. Typically, the divider comprises a high frequency divider (i.e., the prescaler 232), and a lower frequency divider 289.

An RF signal at the signal input 158 of the power amplifier 160 on connection 158 will produce a corresponding RF signal at the output 162 of the power amplifier 160 with an amplitude change corresponding to an amplification factor that is selected for the power amplifier. The amplification factor of the power amplifier is determined by the voltage level at the gain control input 172 of the power amplifier 160.

The output of the amplitude generator 204 on connection 218 is combined with the output of a power ramp element 206 in a multiplier 214. The power ramp element 206 controls the ramp-up and ramp-down portion of the transmit burst, as well as the absolute power level during the burst. This is performed independent of the modulation. The output of the multiplier 214 is passed to the AM-PM predistortion element 226 via connection 222 and to an AM-AM predistortion element 224 via connection 284. The AM-AM predistortion element 224 modifies its input to produce an output which is sent to an amplitude DAC 142. The AM-AM predistortion element 224 will be discussed in greater detail below. The amplitude DAC 142 takes a digital input on connection 278 and converts it into an analog voltage at the input to the amplitude DAC LPF (low pass filter) 248 on connection 288. The output of the amplitude DAC LPF 248 is connected to the gain control input of the power amplifier via connection 172. In this embodiment, the amplitude DAC 142 and the DAC LPF 248 constitute the power control element 145 shown in FIG. 1.

When the power amplifier 160 exhibits an ideal linear input-output characteristic the RF signal at the signal input 158 of the power amplifier 160 will be linearly related to the signal at the output of the power amplifier 160 on connection 162 with only a scaling difference between the two. The scaling difference is completely determined by the amplification factor selected by the signal at the gain control input 172 of the power amplifier 160. In operation, the input-output characteristic of the power amplifier 160 will deviate from being absolutely linear. Characterization of the non-linear nature of a power amplifier can be done in a number of ways. A well known and well understood method to characterize a power amplifier is in terms of its AM-AM and AM-PM distortion characteristics. AM-AM distortion is present when the amplification factor of the power amplifier does not change linearly with changes in the signal at the gain control input 172 of the power amplifier 160. AM-PM distortion is present when there is a phase offset between the RF signal at the signal input 158 of the power amplifier 160 and the RF signal at the output 162 of the power amplifier 160. This phase offset exhibits a dependency on the amplitude of the signal at the gain control input 172 of the power amplifier 160.

The effect of AM-AM and AM-PM distortion is to degrade the spectral characteristics of the RF signal at the output of the power amplifier 160. This degradation can cause a communication system to fail to meet specified performance requirements. In order to ameliorate the impact of AM-AM and AM-PM distortion a well known technique is to apply AM-AM and AM-PM predistortion to the amplitude and phase components as shown in FIG. 2. The AM-AM and AM-PM predistortion characteristics can be determined either by analysis of the signal at the output of the power amplifier when a known signal is applied at the inputs of the power amplifier or by analysis of the design of the power amplifier. The approach in the latter case is inflexible and does not compensate for deviations introduced in the manufacturing process. The approach in the former case can be implemented using either a dynamic or a static methodology. In the static case the AM-AM and AM-PM characteristics of the power amplifier are determined as part of the manufacturing process and stored for later use while in the dynamic case the AM-AM and AM-PM characteristics of the power amplifier are continuously updated based on observations of the signal at the output of the power amplifier.

The signal supplied by the amplitude generator 204 represents the desired AM control signal. This signal is provided on connection 284 to the AM-AM predistortion element 224 and on connection 278 to the amplitude DAC 142. The output of the amplitude DAC 142 on connection 288 is the V_{APC} signal and determines the power output of the power amplifier 160.

In accordance with an embodiment of the invention, the output of the power amplifier 160 on connection 162 is supplied to a switch 166, which also functions as a coupler. Illustratively, the switch 166 is a three-way switch that controls whether the amplified signal on connection 162 is transferred to antenna 164, transferred directly from the transmitter output to the receiver input, or whether a received signal from antenna 164 is supplied to filter 168 (FIG. 1) in the receiver 170.

In one embodiment, the switch 166 is positioned so that the output of the transmitter 200 is supplied directly to the receiver 170 so that the transmitter characteristics, and in particular, the AM-AM and AM-PM characteristics, can be analyzed and compensated. The output of the switch 166 is supplied to the input of the receiver 170. A local oscillator signal is taken from the TX VCO 244 and supplied to a phase shift element 262 in the receiver 170 to generate the in-phase (I) and quadrature-phase (Q) components of the RF signal V_{RF} at the output of the power amplifier 160. The phase shifted I and Q signals are processed by low pass filters 264 and 266, and are converted to the digital domain by analog-to-digital converters 134. The downconverted and demodulated baseband (DC) level I and Q information signals are sent via connection 128 to a scaler 270. The scaler 270 normalizes the value of the I and Q information signals and provides them on connection 272 to a magnitude/phase determination element 274. The magnitude/phase determination element 274 determines the magnitude and phase of the baseband I and Q information signals on connection 272. In an embodiment, the scaler 270 and the magnitude/phase determination element 274 are implemented in hardware. However, other implementations are possible. In an embodiment, the magnitude of the I and Q information signals is determined using the formula MAG=SQRT(I²+Q²) and the phase of the I and Q information signals is determined using the formula Phase=TAN⁻¹ (Q/I). However, other computations can be used to determine the power/amplitude and the phase of the I and Q information signals.

The phase information computed by the magnitude/phase determination element 274 is supplied to the AM-PM predistortion element 226 via connection 282 and the amplitude information computed by the magnitude/phase determination element 274 is supplied to the AM-AM predistortion element 224 via connection 276. The AM-PM predistortion element 226 uses the phase information from the magnitude/phase determination element 274 to adjust the phase of the transmit signal to compensate for non-linearities in the power amplifier caused by AM-PM conversion in the power amplifier. Similarly, the AM-AM predistortion element 224 uses the amplitude information from the magnitude/phase determination element 274 to adjust the amplitude of the transmit signal to compensate for non-linearities in the power amplifier caused by AM-AM conversion in the power amplifier.

The output of the magnitude/phase determination element 274 is used to develop compensation tables 360, which can also be referred to as calibration or predistortion tables, and which are stored in the memory 122 (FIG. 1). During initialization upon power-up, these tables are transferred to dedicated random access memory (RAM) (not shown) in the RF/MSD subsystem 130. During normal operation, the predistortion circuits 224 and 226 are operating on the compensation table in the RAM.

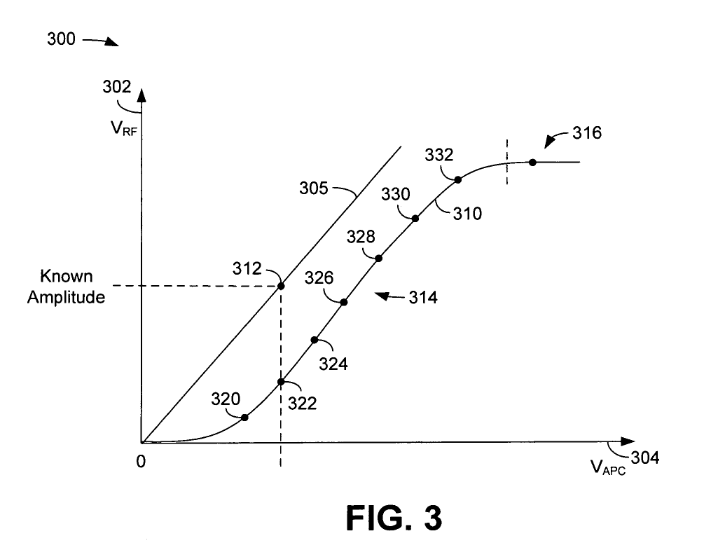

FIG. 3 is a graphical representation of the relationship between control voltage V_{APC} and output power, represented as a voltage, V_{RF} of the power amplifier 160 of FIGS. 1 and 2. The vertical axis 302 represents output power as a voltage V_{RF} and the horizontal axis 304 represents the control voltage V_{APC} supplied to the power amplifier 160 from the DAC LPF 248 of FIG. 2. The curve 310 illustrates the actual power output of the power amplifier 160 as a function of control voltage V_{APC}. The curve 310 is generally linear in the region 314 and enters saturation approximately in the region 316. The saturation region 326 is well defined and can be used as a reference point. The power output of the power amplifier at the saturation point is well defined and consistent over a number of different individual amplifiers. The power (AM) calibration points 320 through 332 are generated relative to the saturation point 316 (i.e., at −6 dB, −12 dB, −15 dB,and so on). The curve 310 is very linear at higher powers so larger steps are used at high power. As power is reduced, the curve 310 is generally less linear, so smaller steps are used. Optionally, an external power meter 165 (FIG. 2) can be used to measure the power at the saturation point 316, or the expected power value can be stored in memory. The deviation from an ideal (linear) curve 305 is measured, using an appropriate number of points, and by combining a correction factor with each sample of the amplitude signal, a linearized result is obtained. The compensation tables 360 (FIG. 1) contain the correction factors.

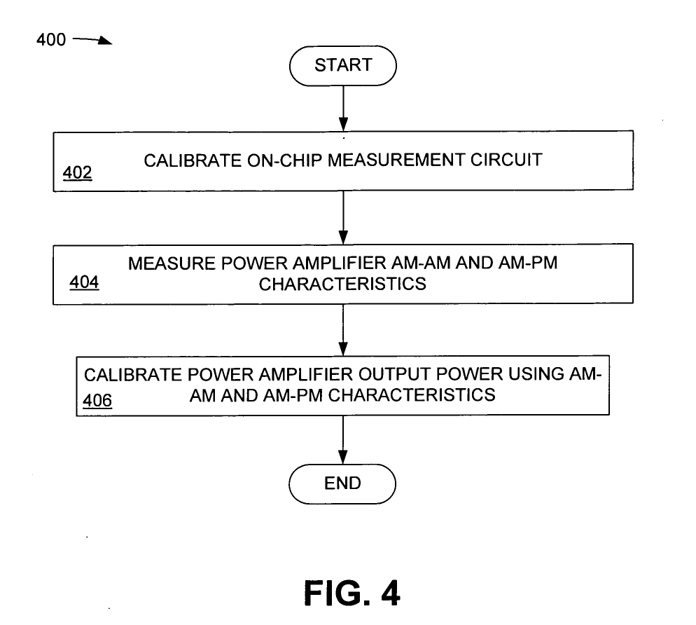

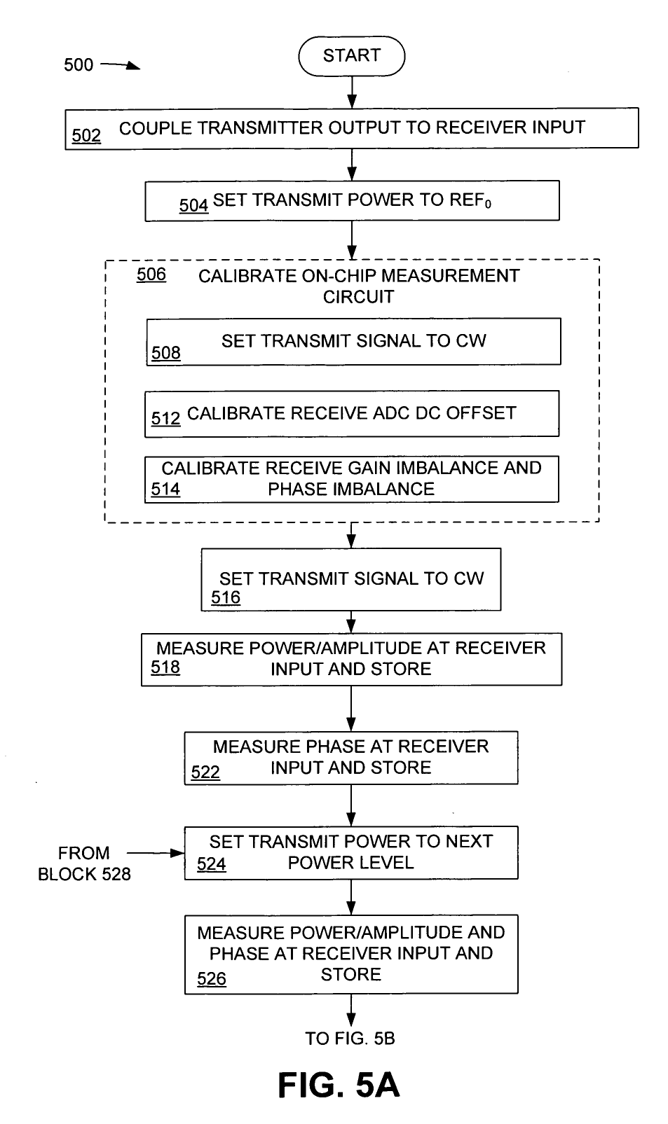

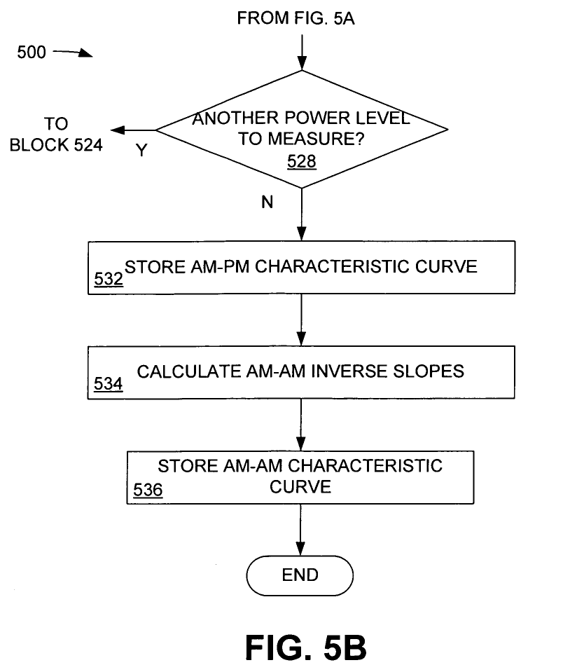

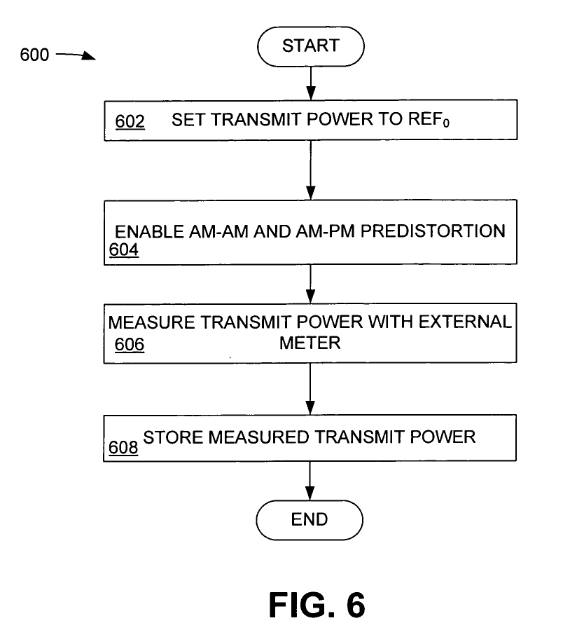

FIG. 4 is a flow chart 400 describing the operation of an embodiment of the invention. The blocks in the flow chart 400, and the flow charts to follow, illustrate one possible manner of implementing the on-chip calibration system and can be executed in the order shown, out of the order shown or substantially in parallel. In block 402, the on-chip measurement components, such as the receiver DAC's, the phase DAC 217 that is embedded in the phase modulator 216 (FIG. 2, ADC's and other circuits are calibrated. In block 404, the AM-AM and the AM-PM characteristics of the power amplifier 160 are determined and a history of power amplifier characteristics is collected. This will be described in detail below in FIGS. 5A and 5B. In block 406, the output of the power amplifier 160 is calibrated using the AM-AM and the AM-PM characteristics determined in block 404. This will be described in detail below in FIG. 6.

FIGS. 5A and 5B are a flow chart 500 collectively illustrating the measurement of the AM-AM and the AM-PM characteristics of the power amplifier 160, referred to in block 404 of FIG. 4. In block 502, the output of the power amplifier 160 is coupled to the input of the receiver 170. In block 504, the transmit power of the portable transceiver 100 is set to a reference voltage level referred to as REF₀ using the V_{APC} signal.

In block 506, the on-chip measurement circuits are calibrated, as described above in block 402. In block 508, the transmit signal is set to operate at a continuous power (referred to as continuous wave, or CW). In block 512, the DC offset of the analog-to-digital (ADC) converters 134 in the receiver 170 are calibrated. In block 514, the gain imbalance and the phase imbalance in the receiver 170 are calibrated. Those having ordinary skill in the art will understand how to calibrate the receiver 170 for DC offset, gain imbalance and phase imbalance. An exemplary calibration system for performing DC offset, gain imbalance and phase imbalance calibration can be found in co-pending, commonly assigned U.S. Utility patent application Ser. No. 11/100,172, entitled “Internal calibration System For A Radio Frequency (RF) Transmitter,” which is hereby incorporated by reference.

In block 516, the transmit signal is set to operate at a continuous power (referred to as continuous wave, or CW). In block 518, the power output/amplitude of the power amplifier 160 is measured at the input 254 of the receiver 170 using the magnitude/phase determination element 274 by performing the calculation MAG=SQRT(I²+Q²). The measured power/amplitude is stored in the memory 122 (FIG. 1) to develop a history of power amplifier characteristics. In block 522, the phase of the output of the power amplifier 160 is measured at the input 254 of the receiver 170 using the magnitude/phase determination element 274 by performing the calculation Phase=TAN⁻¹(Q/I). The measured phase is stored in the memory 122 (FIG. 1). In block 524, the transmit power of the portable transceiver 100 is set to the next power level. In block 526, the power output/amplitude and the phase of the output of the power amplifier 160 is measured at the input 254 of the receiver 170 using the magnitude/phase determination element 274 by performing the calculations MAG=SQRT(I²+Q²) and Phase=TAN⁻¹(Q/I). The measured power/amplitude and phase is stored in the memory 122 (FIG. 1).

In block 528, it is determined whether the power/amplitude and phase outputs of the power amplifier 160 are to be measured at any other power levels. If it is determined that the power/amplitude and phase outputs of the power amplifier 160 are to be measured at another power level, then the process returns to block 524. If the measurements are complete, the process proceeds to block 532 where the characteristic curve for the AM-PM conversion is stored in the memory 122 as the compensation tables 360. The compensation table 360 represents power versus phase, (which is the AM-PM characteristic. In block 534, the AM-AM inverse slope is calculated. The AM-AM characteristic is a table representing V_{APC} versus power output (V_{RF}). The inverse of the AM-AM table is used to multiply the AM signal samples to compensate for the power amplifier characteristics. In block 536, the characteristic curve of the AM-AM conversion is stored in the memory 122.

FIG. 6 is a flow chart 600 illustrating the calibration of the output power of the power amplifier using AM-AM and AM-PM characteristics, referred to in block 406 of FIG. 4. In block 602, the transmit power of the portable transceiver 100 is set to a reference voltage level referred to as REF₀ using the V_{APC} signal. In block 604, the AM predistortion element 224 (FIG. 2) and the PM predistortion element 226 (FIG. 2) are enabled. In block 606, the transmit power is measured with an external power meter 165 (FIG. 2). In block 608, the measured transmit power is stored in the memory 122 (FIG. 1).

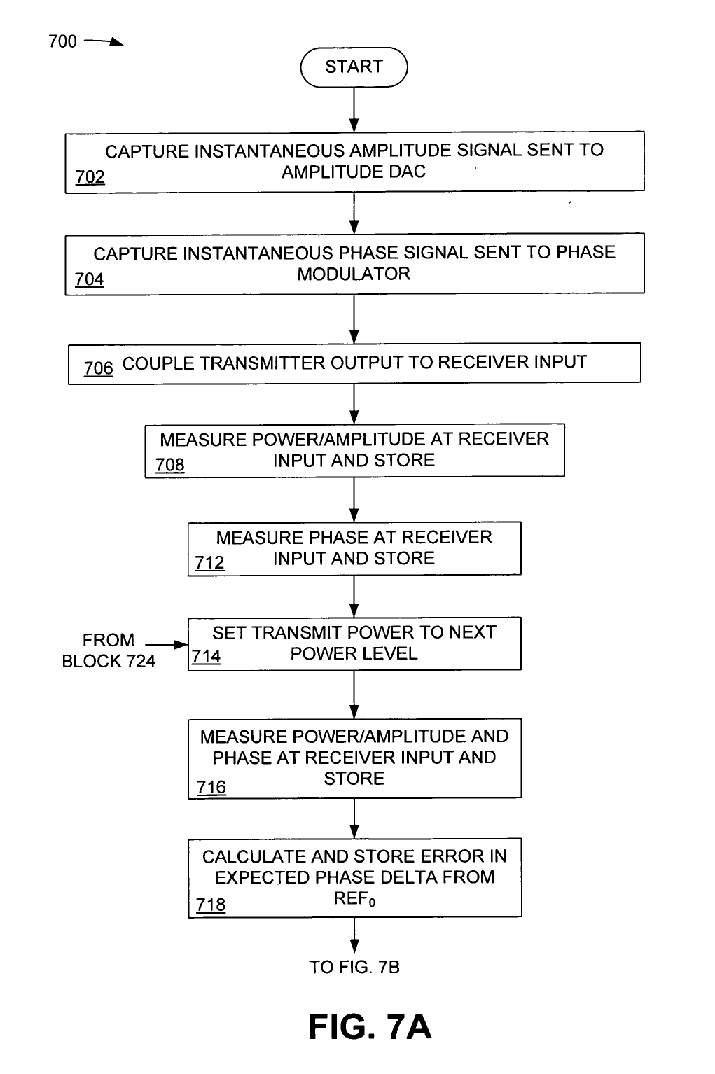

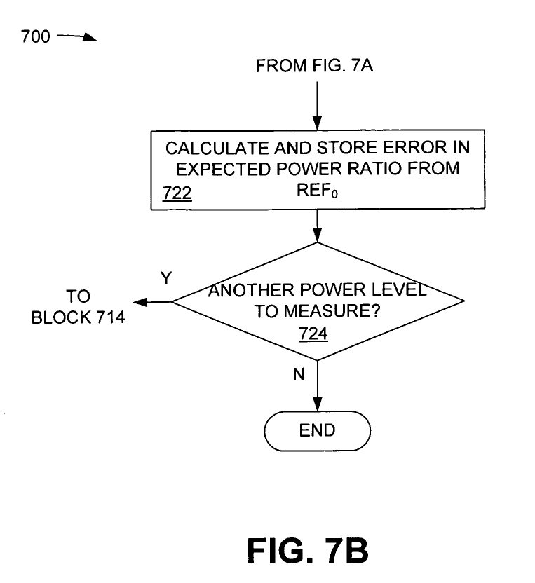

FIGS. 7A and 7B are a flow chart 700 collectively illustrating an embodiment of the invention in which the on-chip calibration is performed periodically when the portable transceiver is in operation. In block 702, the instantaneous amplitude signal sent to the amplitude DAC 142 (FIG. 2) is captured in the memory 122 (FIG. 1). In block 702, the instantaneous phase signal (without predistortion) that is input to the phase modulator 216 (FIG. 2) is captured in the memory 122 (FIG. 1). In block, 706, the output of the power amplifier 160 is coupled to the input of the receiver 170. In block 708, the power output/amplitude of the power amplifier 160 is measured at the input 254 of the receiver 170 using the magnitude/phase determination element 274 by performing the calculation MAG=SQRT(I²+Q²). The measured power/amplitude is stored in the memory 122 (FIG. 1). In block 712, the phase of the output of the power amplifier 160 is measured at the input 254 of the receiver 170 using the magnitude/phase determination element 274 by performing the calculation Phase=TAN⁻¹(Q/I). The measured phase is stored in the memory 122 (FIG. 1).

In block 714, the transmit power of the portable transceiver 100 is set to the next power level. In block 716, the power output/amplitude and the phase of the output of the power amplifier 160 is measured at the input 254 of the receiver 170 using the magnitude/phase determination element 274 by performing the calculations MAG=SQRT(I²+Q²) and Phase=TAN⁻¹(Q/I). The measured power/amplitude and phase is stored in the memory 122 (FIG. 1). In block 718, the error in the expected phase delta from the reference voltage level REF₀ is calculated by, for example, the DSP 126 (FIG. 1), or by a dedicated processor associated with the RF/MSD subsystem 130, and stored in the memory 122 (FIG. 1). In block 722, the error in the expected power ratio from the reference voltage level REF₀ is calculated by, for example, the DSP 126 (FIG. 1), or by a dedicated processor associated with the RF/MSD subsystem 130, and stored in the memory 122 (FIG. 1).

In block 724, it is determined whether the power/amplitude and phase outputs of the power amplifier 160 are to be measured at any other power levels. If it is determined that the power/amplitude and phase outputs of the power amplifier 160 are to be measured at another power level, then the process returns to block 714. If the measurements are complete, the process ends and calibration is complete.

While various embodiments of the invention have been described, it will be apparent to those of ordinary skill in the art that many more embodiments and implementations are possible that are within the scope of this invention. Accordingly, the invention is not to be restricted except in light of the attached claims and their equivalents.

What is claimed is:

1. An on-chip calibration system for a transceiver, comprising:
a transmitter;
a receiver;
a phase and amplitude determination element configured to determine amplitude and phase characteristics of an output signal generated in the transmitter, the signal representing transmitter characteristics;
an amplitude comparison element configured to compare the signal representing transmitter characteristics with a desired amplitude signal and generate an amplitude compensation signal;
an AM predistortion element configured to modify an ideal AM signal with the amplitude compensation signal;
a phase comparison element configured to compare the signal representing transmitter characteristics with a desired phase signal and generate a phase compensation signal; and
a PM predistortion element configured to modify an ideal phase signal with the phase compensation signal.

2. The system of claim 1, wherein the desired AM and PM signals are developed using a history of a power amplifier characteristic.

3. The system of claim 2, wherein the amplitude and phase characteristics are used to develop an AM-PM characteristic curve and an AM-AM characteristic curve for the power amplifier.

4. The system of claim 1, wherein the AM predistortion signal and the PM predistortion signal are applied to the transmitted signal.

5. The system of claim 1, wherein an output of the transmitter is provided to the receiver via a leakage path.

6. The system of claim 1, further comprising a coupler configured to couple a portion of the output signal of the transmitter to the receiver.

7. The system of claim 1, wherein the output signal generated in the transmitter is a data signal.

8. The system of claim 7, wherein a frequency of the data signal is within an overlap region formed where a transmit band overlaps a receive band.

9. The system of claim 1, wherein AM-AM and AM-PM conversion in a power amplifier associated with the transmitter are simultaneously compensated.

10. A method for performing on-chip calibration for a transceiver, comprising:
providing an output signal;
routing the output signal to a receiver;
determining amplitude and phase characteristics of the output signal, the output signal representing transmitter characteristics;
comparing the amplitude characteristics of the transmitted signal to a desired AM signal and developing an AM predistortion signal;
comparing the phase characteristics of the transmitted signal to a desired PM signal and developing a PM predistortion signal; and
compensating the amplitude and phase characteristics of the output signal.

11. The system of claim 10, wherein the desired AM and PM signals are developed using a history of a power amplifier characteristic.

12. The system of claim 11, further comprising using the amplitude and phase characteristics to develop an AM-PM characteristic curve and an AM-AM characteristic curve for the power amplifier.

13. The system of claim 10, further comprising applying the AM predistortion signal and the PM predistortion signal to the transmitted signal.

14. The system of claim 10, wherein the output signal is provided to the receiver via a leakage path.

15. The system of claim 10, further comprising coupling a portion of the output signal to the receiver.

16. The system of claim 10, wherein the output signal generated in the transmitter is a data signal.

17. The system of claim 16, wherein a frequency of the data signal is within an overlap region formed where a transmit band overlaps a receive band.

18. The system of claim 10, further comprising simultaneously compensating AM-AM and AM-PM conversion in a power amplifier associated with the transmitter.

19. An on-chip calibration system for a portable transceiver, comprising:
a transmitter including a power amplifier configured to provide an output signal;
a receiver configured to receive the output signal;
a phase and amplitude determination element configured to determining amplitude and phase characteristics of the output signal, the output signal representing transmitter characteristics;
an amplitude comparison element configured to compare the amplitude characteristics of the transmitted signal to a desired AM signal;
an AM predistortion element configured to develop an AM predistortion signal and apply the AM predistortion signal to the desired AM signal;
a phase comparison element configured to compare the phase characteristics of the transmitted signal to a desired PM signal; and
a phase predistortion element configured to develop a PM predistortion signal and apply the PM predistortion signal to the desired PM signal.

20. The system of claim 19, wherein the desired AM and PM signals are developed using a history of a power amplifier characteristic.

21. The system of claim 20, wherein the amplitude and phase characteristics are used to develop an AM-PM characteristic curve and an AM-AM characteristic curve for the power amplifier.
